(19) United States
(12) Patent Application Publication
(10) Pub. No.: US 2006/0132325 A1
(43) Pub. Date: Jun. 22, 2006

(54) Transmitter

(75) Inventors: Masaki Fujii, Kasugai (JP); Shuji Yamashita, Nagoya (JP)

Correspondence Address: BEYER WEAVER & THOMAS LLP, P.O. BOX 70250, OAKLAND, CA, 94612-0250, US

(73) Assignee: OMRON Corporation

(21) Appl. No.: 11/305,505

(22) Filed: Dec. 16, 2005

(30) Foreign Application Priority Data
Dec. 16, 2004 (JP) 2004-364612

(51) Int. Cl. G08C 19/00; G08C 19/12; G05B 19/00

(52) U.S. Cl. 340/825.69; 340/5.64; 340/442; 340/426.17; 341/176; 340/5.61

(57) ABSTRACT

A transmitter transmits a wireless signal such as a request signal for a smart entry system by modulating a rectangular carrier wave with a base band signal from an antenna. A control unit is adapted to change the duty ratio of the carrier wave so as to change the transmission output of the wireless signal and thus to change its reception range. The control unit may also serve to change the transmission output of the wireless signal by varying the driving voltage that is applied to the antenna.

Priority is claimed on Japanese Patent Application 2004-364612 filed Dec. 16, 2004.

### BACKGROUND OF THE INVENTION

This invention relates to a transmitter of wireless signals for a remote control system for a vehicle or a tire pressure monitoring system (TPMS) and is in the technical field of adjusting the range in which wireless signals from such a transmitter can be received.

It has recently become common to provide a vehicle with a system such as a remote control system or a tire pressure monitoring system for carrying out wireless communications.

Representative examples of remote control system for a vehicle include those capable of automatically and efficiently unlocking a vehicle by a one-touch operation without using a mechanical key (such as so-called keyless entry systems and smart entry systems which are a more advanced type). As disclosed in Japanese Patent Publication Tokkai 10-308149, a smart entry system is adapted to interpret the approach of or a touch by the user to or on an external door handle as an unconscious expression of the user's intent, using this as a trigger to transmit a request signal (usually a wireless electromagnetic signal on the LF band) from a component carried on the vehicle towards a portable device (transceiver) carried by the user, and automatically unlocking the door by using as the necessary condition the receipt of an answer signal (usually a wireless electromagnetic signal on the UHF band) including a proper ID code from the device carried by the user in response to this request signal.

There are two kinds of antennas for transmitting a request signal, one of the kinds for use inside the vehicle and the other for use outside the vehicle. Moreover, the kind for use outside may be for use either on the left-hand side or on the right-hand side of the vehicle. Antennas of all these kinds are installed on a vehicle, and it is a requirement that the request signal transmitted from each of them should be receivable by the transceiver carried by the user within a specified range. In order to judge whether or not the transceiver is inside the vehicle such that it can be prevented from being erroneously locked in, for example, the range of the antenna for use inside the vehicle should not extend to the exterior of the vehicle, and the range must cover every corner of the interior. In order to prevent a situation where the door may become unlocked while the user carrying the transceiver is on one side (such as the left-hand side) of the vehicle when another person happens to approach the door on the other side (such as the right-hand side) of the vehicle or to prevent another undesirable situation where the door may become unlocked simply because the user carrying the transceiver happened to approach the vehicle, the range in which the signal can be received should not be too wide (to reach the opposite side of the vehicle) but should have an appropriate width.

Tire pressure monitoring systems are for transmitting a request signal (of the kind described above) from the transmitter of a controller on the vehicle main body to a sensor unit (containing a receiver) inside a tire, having an answer signal (usually a wireless electromagnetic signal on the UHF band) transmitted to the controller on the vehicle main body from the sensor which received the request signal, containing measured data on the air pressure inside the tire such that an alarm can be outputted if it is judged that an abnormal condition exists in the tire pressure. Prior art tire pressure monitoring systems were not adapted to distinguish which of the four tires is transmitting the answer signal, and the alarm was outputted whenever any one of the tires was found to be in an abnormal condition. The user could tell from an alarm signal only that at least one of the tires was in an abnormal condition, but could not ascertain which of the tires was in an abnormal condition. Recently, however, the function for identifying the tire in an abnormal condition is also coming to be desired. For this purpose, it is necessary to provide each of the tires with an antenna for a request signal (such as an LF antenna) and the range in which the request signal transmitted from each antenna can be received must be appropriately set such that the request signal from each antenna will be dependably received only by the sensor unit (such as an LF receiver) of the corresponding tire.

The range in which wireless signals can be received in the case of a system as described above, however, is largely affected by the shape of the vehicle and the environmental conditions. Thus, even if it may be the same in the free space, it may be different in many situations, depending on the manner in which the system is set on a vehicle. In other words, even if transmitters (each comprising a transmission antenna and a transmission circuit) of the same specification are installed to vehicles and receivers (portable transceivers and sensor units) of the same specification are similarly set, the range for the reception varies, depending upon the vehicle type and the setting position of the transmission antenna. Thus, the transmission outputs of the transmitters must be made individually different according to the conditions such as the vehicle type and the position of installation in order to obtain an appropriate range for the reception.

In prior art systems, however, the transmission outputs were fixed, depending upon the circuit constants such as the antenna resistance of the transmitter, and the specifications of transmitters (such as the circuit constants) were set according to the individual applications.

Japanese Patent 3480495 discloses a keyless entry system with a device mounted to a vehicle adapted to monitor the power or electric field of the signals transmitted from a portable device and to adjust the transmission power of the portable device or the reception sensitivity of the mounted device so as to have a value corresponding to this power or field intensity. This patent, however, does not provide any detailed explanation how to carry out this adjustment of the transmission power of the portable device or the reception sensitivity of the mounted device itself.

With conventional transmitters as described above, since their effective specifications change according to the conditions of their applications, there are effectively many transmitters with different constants and this gives rise to the problem of increased management work load.

An attempt may be made in view of this problem to make the transmission output variable by additionally providing a circuit for making the voltage supplied to the antenna of the transmitter (or the driving voltage) variable and adjusting the range of reception by varying the transmission output according to the application conditions. If it is tried to vary the transmission output only by changing the driving voltage, however, a sufficiently large range for varying the transmission output cannot be obtained and there are situations where the range for varying cannot be sufficiently adjusted. In the case of a vehicle, since the maximum voltage of power (battery mounted to the vehicle) is about 13V, the power voltage supplied to the antenna can be varied only within a limited range of about 5V-7V unless a step-up circuit is provided. In short, the reception range cannot be adjusted sufficiently.

### SUMMARY OF THE INVENTION

It is therefore an object of this invention to provide a transmitter for use in a remote control system of a vehicle or the like, capable of sufficiently adjust the range of reception according to the application conditions.

A transmitter according to this invention may be characterized not only as comprising an antenna and a control unit for causing to transmit from the antenna a wireless signal formed by modulating a carrier wave which is made into a rectangular wave having a specified duty ratio with a base band signal but also wherein the control unit serves to change the duty ratio of the carrier wave to thereby change the transmission output of the wireless signal and to thereby change the reception range of the wireless signal within which the wireless signal can be received by a specified receiver.

With such a transmitter, the reception range can be adjusted according to its application conditions merely by changing the duty ratio of the carrier wave. Since the transmission output is changed as the duty ratio is adjusted, the reception range can be changed within a relatively large range independent of the source voltage. Since the reception range can be varied without changing the driving voltage, the circuit for varying the driving voltage to be applied to the antenna can be dispensed with.

The transmitter of this invention may further serve to change the transmission output of the wireless signal by varying the driving voltage that is applied to the antenna. With a transmitter of this kind, the reception range can be adjusted within a significantly larger range and the transmitter can be used under a greater variety of application conditions.

The control unit may still further be adapted to serve to change the frequency of the carrier wave for changing the reception range of the wireless signal such that the transmitter can be used under an even greater range of application conditions.

### BRIEF DESCRIPTION OF THE DRAWINGS

FIG. 1 is a circuit diagram of a transmitter embodying this invention.

FIG. 2A is a block diagram showing the structure of a receiver, and FIG. 2B is a drawing of an example of method for setting a range of reception.

FIG. 3A is a drawing of the relationship between the driving voltage and the transmission output of the transmission antenna, and FIG. 3B is a drawing of the change in the signal waveform as this driving voltage is varied.

FIG. 4A is a drawing of the relationship between the duty ratio and the transmission output of the carrier wave, and FIG. 4B is a drawing of the change in the signal waveform as this duty ratio is varied.

FIG. 5A is a drawing of the relationship between the transmission frequency and the reception sensitivity, and FIG. 5B is a drawing of the change in the signal waveform as this transmission frequency is varied.

### DETAILED DESCRIPTION OF THE INVENTION

The invention is described next by way of an example.

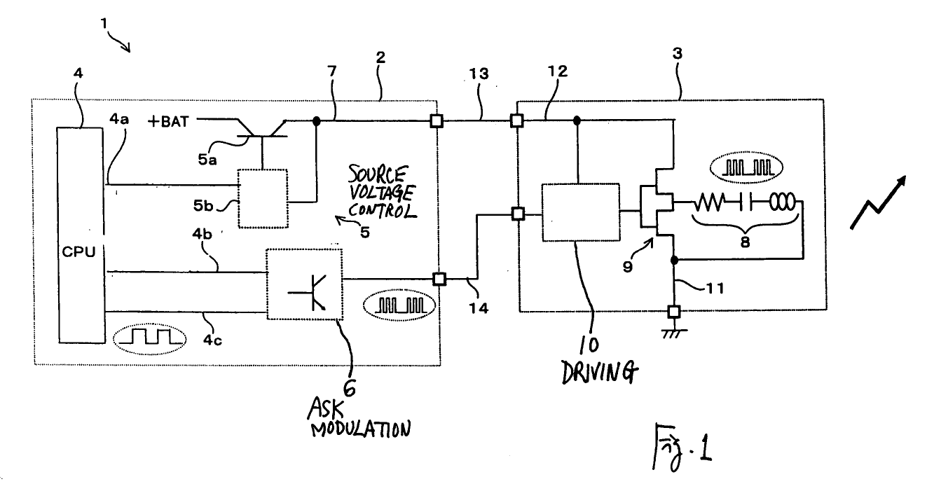

FIG. 1 is a circuit diagram for showing the structure of a transmitter 1 for transmitting a request signal in the LF band for a smart entry system or a tire pressure monitoring system for a vehicle.

The transmitter 1 comprises a control unit circuit 2 and an antenna circuit 3. A plurality of such transmitters (or at least their antenna circuits 3) are used in the case of a smart entry system for the left-hand and right-hand doors or for the vehicle interior. In the case of a tire pressure monitoring system, a plurality of them are used for the individual tires. The control unit circuit 2 is provided inside a control unit for controlling a smart entry system or a tire pressure monitoring system. The antenna circuits 3 in the case of a smart entry system are each set inside the left-hand and right-hand doors and the interior of the vehicle. In the case of a tire pressure monitoring system, they are each set near a tire (such as inside the tire housing). Whether each element of the circuit belongs to the control unit circuit 2 or the antenna circuit 3 is a matter of design philosophy and FIG. 1 is not intended to limit the scope of the invention. If there are a plurality of antenna circuits 3, there may correspondingly be a plurality of control unit circuits 2 but a single control unit circuit 2 may be used in common, switching conveniently the antenna circuit 3 to be connected.

In this situation, the control unit circuit 2 may comprise a control circuit 4 with a microcomputer having a CPU, a source voltage control circuit 5 and an ASK modulation 5 circuit 6. The control circuit 4 has output terminal 4a for outputting a source varying command (D/A output), output terminal 4b for outputting a carrier wave (rectangular wave having a specified duty ratio) in the LF band and output terminal 4c for outputting LF communication data (base band signal of a request signal). This control circuit 4 has the function of varying the duty ratio and/or the frequency of the carrier wave outputted from output terminal 4b and may be also referred to as the duty varying means, the frequency varying mean, or reception range varying means.

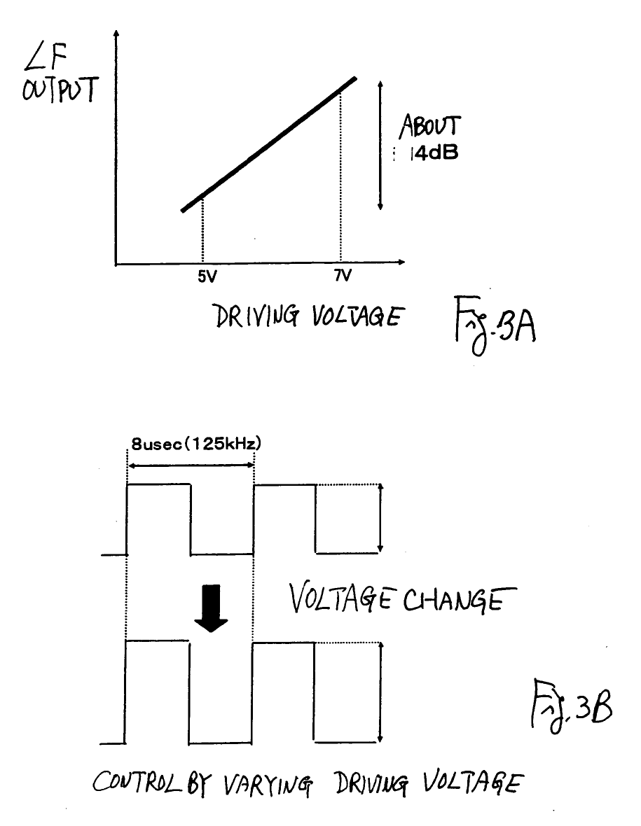

The source voltage control circuit 5 comprises a transistor 5a for opening and closing the power line 7 connected to the output of the battery mounted to the vehicle and three-terminal regulator 5b for driving this transistor 5a based upon a source varying command outputted from the output terminal 4a of the control circuit 4. As a result of operations based on this source varying command, the driving voltage applied to the antenna main body 8 to be described below is varied as shown in FIG. 3A. The source voltage control circuit 5 and the control circuit 4 together may also be referred to as the voltage control means.

The ASK modulation circuit 6 is logically an equivalent of an AND circuit, having the function of carrying out ASK modulation on the carrier wave outputted from the output terminal 4b with the LF communication data (base band signal of request signal) outputted from the output terminal 4c.

The antenna circuit 3 comprises the antenna main body 8, a driving switch part 9 and a driving part 10. The antenna main body 8 is comprised of a coil, a resistor and a capacitor, one end being connected to a grounding line 11 and the other end being connected through the driving switch part 9 to the grounding line 11 or a power line 12.

The driving switch part 9 is a complementally connected structure (totem pole) with two transistors (FETs) connected in a mutually complementing manner and switches between a discharged state wherein the other end of the antenna main body 8 is connected to the grounding line 11 and a charged state wherein it is connected to the power line 12, depending on the output from the driving part 10.

The driving part 10 is a circuit for driving the driving switch part 9 so as to switch the condition of the antenna main body 8 (the condition of the driving switch part 9) according to the output from the ASK modulation circuit 6 such that a wireless signal (or the request signal) according to the output from the ASK modulation circuit 6 is transmitted to the portable device or the sensor unit of the tire.

The power line 7 of the control unit circuit 2 and the power line 12 of the antenna circuit 3 are connected together by way of an external wiring 13. The output from the ASK modulation circuit 6 of the control unit circuit 2 and the signal input of the driving part 10 of the antenna circuit 3 are also connected together by way of another external wiring 14.

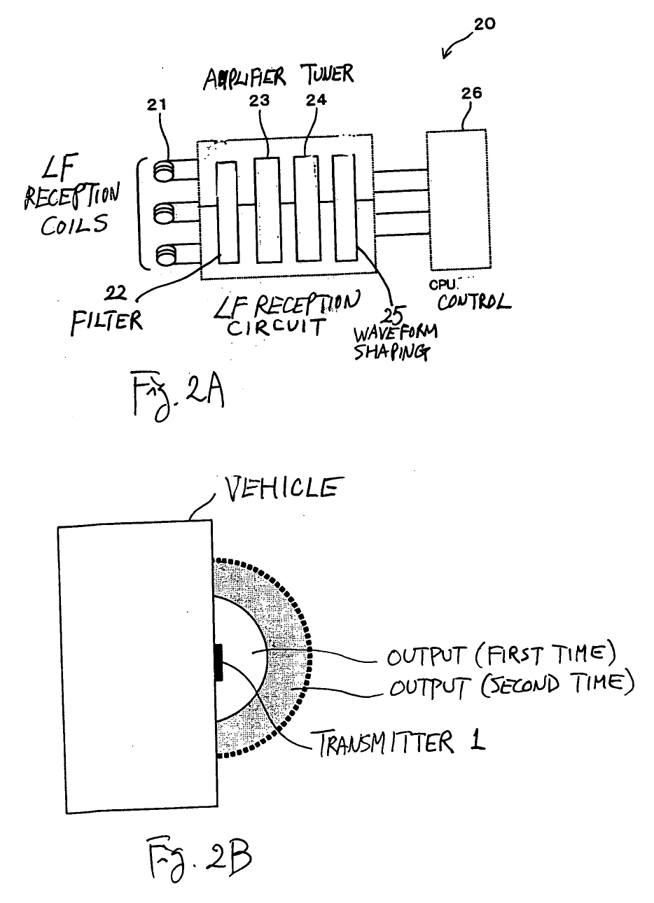

FIG. 2A shows the structure of a receiver 20 of a device to be carried for a smart entry system or a sensor unit which may be set to a tire for a tire pressure monitoring system for receiving a request signal. The receiver 20 is provided with a coil-shaped receiver antenna 21 (LF receiver coil) for receiving a request signal in the LF band, a filter circuit 22 for eliminating the noise (high-frequency components) in the signals received through the receiver antenna 21, an amplifier circuit 23 for amplifying the output from the filter circuit 22, a tuner circuit 24 for taking out a base band signal from the output of the amplifier circuit 23 and outputting it, a waveform shaping circuit 25 for shaping the waveform of the output signal from the tuner circuit 24 and a control unit 26 for receiving the output from the waveform shaping circuit 25 as a base band signal (LF communication data) and carrying out a specified control process.

In the above, the tuner circuit 24 is adapted, for example, to carry out an envelope tuning. The control process carried out by the control unit 26 includes determining, if necessary, whether or not the received request signal is a normal signal and thereafter transmitting an answer signal (of the UHF band) containing a specified ID signal or tire pressure data, etc. The filter circuit 22, the amplifier circuit 23, the tuner circuit 24 and the waveform shaping circuit 25 are together also referred to as the LF reception circuit part.

Characteristic functions of the transmitter 1, and in particular those of its control circuit 4 are explained next. As explained above, the control circuit 4 serves to change parameters at the time of transmitting a request signal such as the source varying command outputted from the output terminal 4a, the duty ratio of the carrier wave outputted from the output terminal 4b and the frequency of the carrier wave outputted from the output terminal 4b). The control circuit 4 is structured such that the source varying command can be varied for changing the driving voltage inputted to the antenna main body 8 through the source line 12 within a range of about 5V-7V as shown, for example, in FIG. 3A. FIG. 3B shows the waveform of the transmission wave when the driving voltage changes in this way. As the driving voltage changes, the amplitude of the transmission wave changes in proportion and the transmission output also changes accordingly. If the driving voltage is varied within the range of 5V-7V under the condition of frequency=125 KHz, the duty ratio of the carrier wave=50%, the transmission output changes by about 4 dB, according to an example.

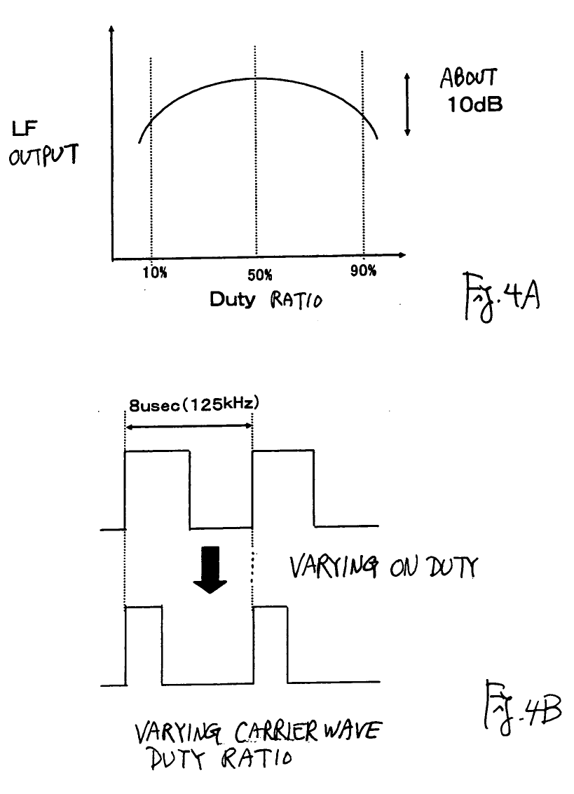

The structure of the control circuit 4 is such that the duty ratio of the carrier wave can be changed within the range of 10-90%, as shown in FIG. 4A. FIG. 4B shows the waveform of the transmission wave when the duty ratio of the carrier wave is changed within this range. As the duty ratio of the carrier wave is varied, the pulse width of the transmission wave changes in proportion and the transmission output changes likewise. As the duty ratio changes by 10-90% under the conditions of the frequency=125 KHz and the driving voltage remaining constant, as shown in FIG. 4A, the transmission output changes by 10 dB according to another example. The areas where the duty ratio is less than 10% or over 90% are usable in principle.

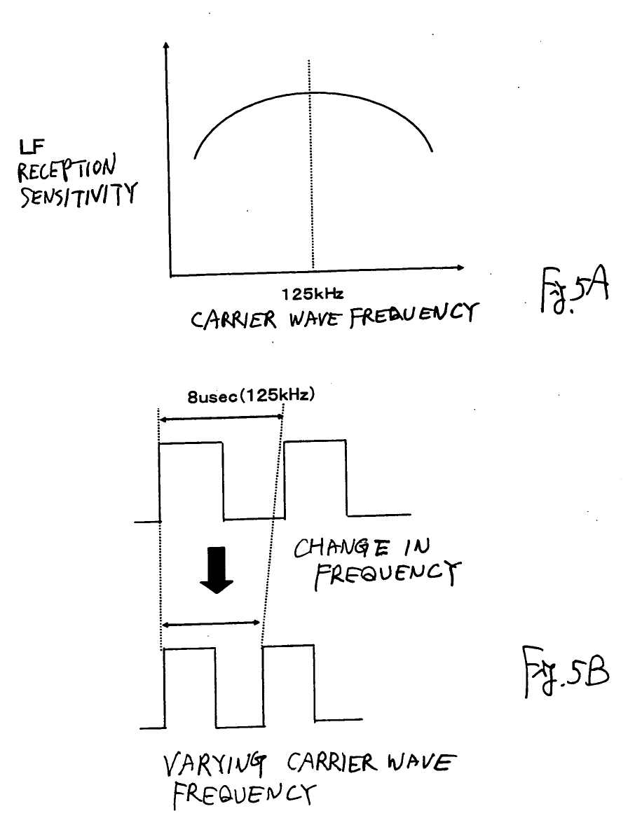

The frequency of the carrier wave is made variable with the center at a normal frequency (such as 125 KHz), as shown for example in FIG. 5A. FIG. 5B is a drawing of the waveform of the transmission wave as the frequency of the carrier wave is changed. If the frequency of the carrier wave is changed, the wavelength of the transmission wave naturally changes in inverse proportion, and the sensitivity (reception sensitivity) of the receiver 20 which is designed for optimum reception at the normal frequency naturally changes. The reception sensitivity changes as shown in FIG. 5A under the conditions of normal frequency=125 KHz, the duty ratio of the carrier wave=50% and the driving voltage being kept constant.

The control circuit 4 is provided with a rewritable non-volatile memory (such as an EEPROM) and reads out under normal conditions the command value of each parameter preliminarily recorded on this non-volatile memory, transmitting a request signal by setting each parameter every time to the same value as this command value. A plurality of command values may be provided for each parameter, corresponding to the kind of the request signal. In the case, for example, of a smart entry system adapted to transmit a request signal twice by varying the range of reception and provided with the function of judging whether or not a portable device being carried by the user is within a specified range as shown in FIG. 2B, according to the presence or absence of a corresponding answer signal, the command values of parameters must be varied such that the range of reception will change between a first output and a second output as shown in FIG. 2B. A plurality of command values of parameters may thus be provided according to the kind of request signal.

The value of each parameter of the non-volatile memory may be set by any of the following methods.

By a first method, these values are preliminarily set experimentally by the automobile maker, for example, according to given application conditions. When the transmitter is mounted, these command values of the parameters are recorded in the non-volatile memory. In this way, the transmitter can be successfully adjusted to the intended range of reception according to the condition of application.

By a second method, the values of transmission output and transmission frequency corresponding to the conditions of application are preliminarily determined, for example, by the automobile maker. When the transmitter is mounted, signal transmission from the transmitter and its transmission output are actually measured, and the command values are rewritten into a non-volatile memory until the measured values of transmission output, etc. reach preliminarily set values (or within preliminarily set allowable ranges around them). By this method, too, an adjustment can be accomplished to a proper range of reception according to the conditions of application.

By the third method, the setting is carried out automatically by the control process of the control circuit 4 after the transmitter is mounted to the vehicle. For example, request signals are transmitted while the parameters are changed from their initial values that would make the range of reception sufficiently small such that the range of reception will gradually expand. Values of the parameters when an answer signal is first received (or values obtained by adding or subtracting a correction value thereto or therefrom) may be automatically set as the command values of a non-volatile memory by the control circuit 4. The control process in this case may be alternatively started from parameter values for a range of reception sufficiently large, changing the parameter values such that the reception range will become smaller until the answer signal fails to be received. It goes without saying that the third method above is advantageous in that the setting can be achieved automatically and the burden on workers can be reduced.

This method of automatically setting the parameters can be more easily carried out in the case of a transmitter of request signals for a tire pressure monitoring system (or a sensor unit) because it can be installed inside a tire of the vehicle. It is harder in the case of a smart entry system because the transmitter is carried by a person and its position changes, but it is not impossible because, for example, the transmitter may be set at a fixed position with respect to the vehicle.

The second and third methods explained above give rise to the problem of choosing command values of which parameters (such as source varying command outputted from output terminal 4a, duty ratio of carrier wave outputted from output terminal 4b or frequency of carrier wave outputted from output terminal 4b) should be varied. A priority order may be determined in this case. For example, the duty ratio may be varied with the other parameters kept at their initial values and if the adjustment is successful, the process is then terminated. If the adjustment is not successful, the source varying command is varied. If adjustment is not successful, then the frequency of the carrier wave is varied for adjustment. Each parameter may be sequentially changed by specified units.

Transmitters according to this invention have the following advantages. Firstly, it becomes possible to adjust the range of reception by its function of varying parameters. Thus, the problem of increased number of transmitters having different constants can be avoided by remote control systems for a vehicle. In the past, for example, different resisters with different resistance values had to be used in the antenna main body 8 according to different ranges of reception. Thus, many transmitters with different constants for the antenna circuit 3 resulted according to different conditions of application. According to the present invention, transmitters with different ranges of reception can be obtained merely by rewriting data (command values) to be recorded by the control circuit 4. Thus, the hardware specifications can be unified and the management work is simplified.

Secondly, since the reception range can be changed by adjusting the duty ratio of the carrier wave to adjust the transmission output, the transmission output (and hence the reception range) can be adjusted in a relatively large range independently of the source voltage. Since the reception range can be modified without changing the voltage to be applied to the antenna (the driving voltage), the invention makes it unnecessary to provide a large circuit for changing the driving voltage. The source voltage control circuit 5 adjusts the driving voltage within the range of about 5V-7V. But for the function for changing the duty ratio of the carrier wave, there would be the requirement to change the voltage more and a larger and more costly circuit would be required. Tire pressure monitoring systems and smart entry systems require an adjustable range of about 20 dB for transmission output. By the example shown in FIG. 4A, however, adjustable range of 10 dB can be realized merely by changing the duty ratio of the carrier wave.

Thirdly, the means for changing the reception range according to the present example is provided with functions for varying the driving voltage and the frequency of the carrier wave. This means that the reception range can be changed not only by controlling the duty ratio but also by varying the driving voltage and the frequency. As a result, the range of adjustment becomes much wider and the transmitter can be applied to a greater variety of application conditions.

It goes without saying that the example described above is not intended to limit the scope of the invention. Many modifications and variations are possible within the scope of the invention. Depending on the extent of adjustment that is required, either or both of the functions for varying the driving voltage and the frequency of the carrier wave may be dispensed with. If the function for varying the driving voltage is dispensed with, the source voltage control circuit 5 becomes unnecessary and the cost of the circuits can be reduced significantly. Moreover, if there is no function for varying the driving voltage, it becomes unnecessary to modify the circuit (to add the source voltage control circuit 5 and the output terminal 4a) when the present invention is applied to a conventional product. The present invention becomes applicable to conventional products merely by varying the program for the control circuit 4.

Although the invention was described above by way of a transmitter adapted to transmit a request signal, the wireless signal according to this invention is not limited to a request signal. Neither is the transmitter of this invention limited to the type mounted to a vehicle. The present invention can be applied to a portable transmitter of a smart entry system (adapted to transmit an answer signal including an ID), that of a keyless entry system (adapted to transmit a signal for unlocking) or a sensor unit of a tire pressure monitoring system (adapted to transmit an answer signal including measured tire pressure value). Even in the case of a wireless signal from a portable transmitter, the reception range can be different, depending on the make or the country in which it is to be used.

This invention is applicable to transmitters for a system other than a vehicle. The invention is not limited to transmitters for transmitting a wireless signal in the LF band. The present invention is effective also for transmitters for transmitting a wireless signal in the UHF band although the LF band is advantageous in that the boundary of the reception range can be set relatively more clearly.

Application of the invention is not limited to transmitters carrying out ASK (amplitude shift keying) modulation. The invention can be applied to transmitters carrying out PSK (phase shift keying) and FSK (frequency shift keying) modulation.

What is claimed is:

1. A transmitter comprising an antenna and a control unit for causing to transmit from said antenna a wireless signal formed by modulating a rectangular carrier wave having a specified duty ratio with a base band signal, said control unit serving to change the duty ratio of said carrier wave to thereby change the transmission output of said wireless signal and to thereby change the reception range of said wireless signal within which said wireless signal can be received.

2. The transmitter of claim 1 wherein said control unit further serves to change the transmission output of said wireless signal by varying the voltage that is applied to said antenna.

3. The transmitter of claim 1 wherein said control unit further serves to change the frequency of said carrier wave for changing the reception range of said wireless signal.

4. The transmitter of claim 2 wherein said control unit further serves to change the frequency of said carrier wave for changing the reception range of said wireless signal.
